(19) United States
(12) Patent Application Publication
(10) Pub. No.: US 2006/0191243 A1
(43) Pub. Date: Aug. 31, 2006

(54) Fire retardant coverings and blankets for horses

(76) Inventor: Lee Ann Manuel, Caledon (CA)

Correspondence Address: GIFFORD, KRASS, GROH, SPRINKLE & CITKOWSKI, P.C, PO BOX 7021, TROY, MI, 48007-7021, US

(21) Appl. No.: 11/363,825

(22) Filed: Feb. 28, 2006

Related U.S. Application Data
(60) Provisional application No. 60/656,405, filed on Feb. 28, 2005.

(51) Int. Cl. B68C 5/00

(52) U.S. Cl. 54/79.2

(57) ABSTRACT

A protective horse covering comprises horse apparel including a flexible fabric layer adapted for wear on a body or a body part of a horse. The fabric layer is made of fire retardant fibers. The covering includes an attachment arrangement for securing the horse apparel to the body or body part. In one preferred embodiment, the horse covering comprises a horse blanket for covering at least a substantial portion of a horse's body, this blanket having an outer fabric layer made of fire retardant or fire resistant fibers. Other protective coverings for horses include leg wraps, face coverings, neck coverings and horse pads.

### PRIOR APPLICATION

This application is based on and claims priority on the basis of earlier filed U.S. Provisional Patent Application No. 60/656,405 filed Feb. 28, 2005.

### BACKGROUND OF THE INVENTION

The present invention relates to coverings, blankets and related items for horses and, in particular, to such products adapted to protect a horse from injury.

A wide variety of products have been developed for use on horses, these products serving various purposes including keeping the animal warm (or cool), protecting the animal from injury and covering an already injured part of the horse's body. Known items developed specifically for horses include horse blankets, horse coolers, sheets, leg wraps, leggings, hock, tendon, and knee bandages, face coverings, neck coverings, body coverings and protective pads. These known items may or may not come equipped with devices or straps for securing the particular item to the horse's body or body part.

Horse apparel has been made of a variety of materials in the past including nylon, polyester, yarn, polyfill and cotton and it is also known to coat the fabric material with Teflon. The particular material that is chosen may be selected to serve a particular function or to provide a particular advantage. For example, known materials that have been used for horse garments may repel and protect against water, wind, rain, snow, heat, cold and insects.

One of the great dangers that horses face is exposure to fire, particularly in a barn or other enclosed area from which the horse cannot escape without assistance. Often a horse barn will be made from flammable wood and contains very flammable materials such as hay, straw and wood shavings which can be used for bedding. Another danger for horses comes from forest fires. Accordingly, it is desirable to provide horse coverings and horse apparel that will provide at least some protection against a fire that may seriously harm or kill a horse. Such protection should preferably provide at least sufficient protection for the horse for a time that will be long enough to allow a horse owner or firemen to come and remove the horse from the barn or other enclosed area.

U.S. Pat. No. 5,068,921 issued Dec. 3, 1991 and entitled Canine Bullet-Proof Vest describes a garment or vest specifically constructed for a dog, this garment including a bullet-resistant pad. Although fire resistance is said to be a criterion for this vest, the indicated fabrics for the body and chest of the garment are cotton, wool and synthetics which will not normally provide sufficient protection against fire and extreme heat. Also, this known vest is not intended for use with or on a horse.

U.S. Patent No. 2001/0027071 A1 published on Oct. 4, 2001 and entitled Protective Multi-layered Liquid Retaining Composite teaches a composite designed to protect a person from a catastrophic event such as a fire. Although this composite material may be used for a person's garment, in particular for the garment of a person who might expect to be exposed to fire or extreme heat, there is no indication or suggestion that this composite material would or could be used for horse apparel. The composite has an outer protective layer which is said to be fire resistant and can be made of a tightly woven, high strength fabric such as a NOMEX-type fabric. NOMEX is a trade-mark of Dupont Corporation.

According to one aspect of the disclosure herein, a horse covering comprises horse apparel including a flexible fabric layer adapted for wear on a body or a body part of a horse. This fabric layer is made of fire retardant fibers. An attachment arrangement is also provided for securing the horse apparel to the body or body part of a horse.

According to another aspect of the present disclosure, a horse covering comprises a horse blanket for covering at least a substantial portion of a horse's body. This blanket has an outer fabric layer made of fire retardant fibers and attachment devices for securing the blanket to the horse's body.

In one preferred embodiment, the outer fabric layer is made of NOMEX™.

Further features and advantages will become apparent from the following detailed description taken in conjunction with the accompanying drawings.

### BRIEF DESCRIPTION OF THE DRAWINGS

FIG. 1 is a perspective view taken from above and from one side of a horse blanket constructed in accordance with this disclosure;

FIG. 2 is a perspective view similar to FIG. 1 but showing the outer layer of the blanket partially cut away to show the underlying layer;

FIG. 3 is a perspective view showing a horse fitted with both a blanket constructed according to this disclosure and a face cover;

FIG. 4 is a perspective view showing a bandage or leg wrap being applied to the leg of a horse;

FIG. 5 is a perspective view illustrating a leg wrap or shin protector attached to the leg of a horse;

FIG. 6 illustrates a partially rolled up leg blanket or leg wrap for a horse;

FIG. 7 is a front view showing a flexible leg wrap or shin protector mounted on the leg of a horse; and

FIG. 8 is a perspective view showing a horse fitted with a blanket, face cover, and leggings constructed according to the invention.

### DETAILED DECRIPTION OF PREFERRED EMBODIMENTS

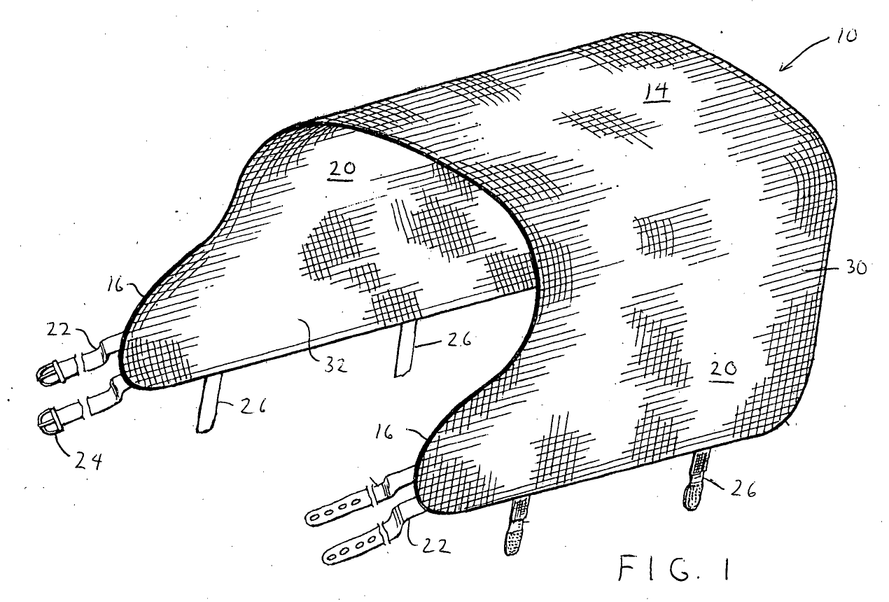

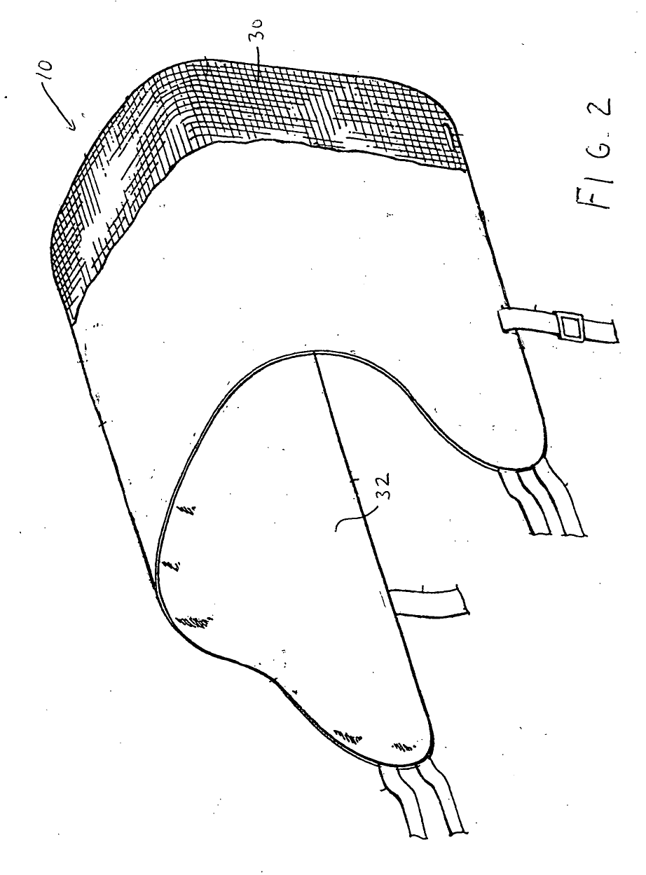

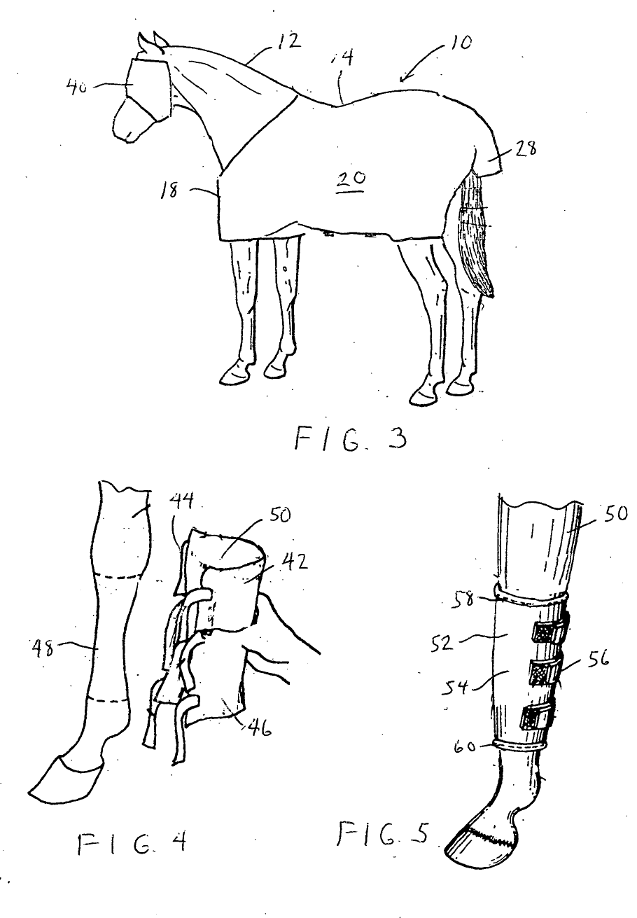

FIGS. 1 to 3 illustrate a horse cooler or horse blanket constructed in accordance with the present disclosure. The horse blanket 10 can be of a standard shape and size and is adapted to be laid on the back of a horse 12 as shown in FIG. 3. This horse blanket includes a top portion 14 intended to cover the back of the horse and two front extensions 16 designed to extend around and cover the front of the horse at 18. The blanket also generally has two side sections 20 that are sized and arranged to cover at least the sides or flanks of the horse as shown in FIG. 3. Front straps 22 are attached to the front extensions 16 and, on at least one side, these straps can be provided with buckles 24. These straps and buckles are used to secure the front end of the horse blanket around the neck of the horse so that the blanket is held in place. The straps and buckles form part of an attachment arrangement for securing the horse blanket to the body of the horse. In addition there are additional straps 26 (also called surcingles or girths) which are provided to secure the blanket around the belly of the horse. The straps can be provided with a variety of securing devices including buckles and hook and loop type fasteners, commonly sold under the trade-mark VELCRO. In view of the intended function of the blanket 10 to provide fire and extreme heat protection to the horse, it is particularly advantageous that the blanket be sized and fitted so that it will wrap around the belly in a manner that completely covers the belly or bottom of the horse's body. The blanket can preferably include a tail cover 28 shown in FIG. 3.

Except for the exterior layer 30 of the blanket, the blanket can be constructed according to any of several known horse blanket constructions. It will be appreciated that some blankets for horses are made to provide warmth in cool weather and other blankets are manufactured for use in warm weather. The latter must be sufficiently cool to wear so that the horses are not uncomfortable in them. According to one standard form of construction for a horse blanket, there is an inner layer 32 adapted for direct contact with the back and sides of a horse. This layer can consist of a light sheet of air pervious material or it can comprise an insulated coat layer with insulation arranged between two sheets of fabric. Covering the inner layer or layers is the exterior or outer layer 30 which is a fabric made of heat resistant, fire retardant fibers. Although a variety of known, fire retardant fabrics can be used for this purpose, in one preferred embodiment, this fabric is made of NOMEX or NOMEX IIIA. These are trade-marks of Dupont Corporation and these materials are a blend of meta-aramid. These preferred materials are inherently resistant to flames, dissipate static, and are resistant to many chemicals including organics, acids and bases. A substantial advantage gained with the use of this type of fabric is that the fire resistance of the fabric does not wash out after one or more laundering operations. Unlike other fire retardant fabrics, spray ons, topical applications and dipping, NOMEX or NOMEX IIIA is permanently fire retardant. Another fire retardant material that can be used for the present horse apparel is KEVLAR, which is a registered trade-mark for para-aramid fiber manufactured by Dupont Inc.

It should be noted that in addition to the outer layer of the blanket being made of fire retardant fibers, the fasteners, belts and/or straps used to secure the blanket 10 in place are preferably also made of fire retardant or fire resistant materials, such as NOMEX. The buckles, hooks or other devices used to secure the straps and adjust same can be made of a non-combustible metal such as stainless steel. Although hook and loop type fasteners can be used to secure the blanket or other apparel in place, this type of fastener may not be available in fire resistant materials.

It is also possible to provide in accordance with the present disclosure a horse covering which consists of a single layer or a single sheet of fabric made of fire retardant fibers such as NOMEX. A horse covering of this type can, for example, be placed over a standard horse blanket which is not fire resistant and can then provide protection substantially equivalent to the above described horse blanket having an outer fabric layer made of fire retardant fibers. Also, a thin horse covering made of a single layer of flexible fiber that is fire retardant can be used in the summer or under other conditions where the warmth and protection provided by a standard horse blanket are not required or are not desired.

Other types of horse coverings can also be made. For example, as shown in FIG. 3 a face cover or eye cover 40 can be provided to protect the face and eyes of the horse and may also be desirable to block the vision of the horse which is required under certain circumstances and indeed may be required when the fire is close by in order to control the horse. Face covers or eye covers are known in the horse trade and the cover 40 can be of standard construction except for the addition of an outer fabric layer made of fire retardant fibers.

FIG. 4 illustrates the use of a leg cover or bandage suitable for a horse's leg. This leg cover or covering 42 can be in the form of a flexible and bendable rectangular cover with attachment straps or ties 44. Again this covering has a fabric layer 46 on its exterior made of fire retardant fibers. In the case of a bandage, there can be underlying layer of gauze or cotton or other materials suitable for application to and for covering a wound or sore region of the horse's leg, this region being indicated at 48. In the case of a leg covering 42, it can provide protection to the horse's leg and provide warmth. The underlying layers 50 can be made of the same material as a standard horse blanket, if desired.

Although the bands or straps 44 can be provided at the outer ends with complimentary VELCRO fasteners or other hook and loop fasteners of sufficient strength to hold the covering in place, again the preferred form of attachment mechanism is one that is resistant to fire and extreme heat and this can include metal hooks or buckles attached to the straps and preferably adjustable so that the covering can be secured firmly in place on the leg. Although these hooks or buckles are not shown in FIG. 4, it will be understood that they can be of standard construction provided that they are able to withstand fire and extreme heat.

Shown in FIG. 5 is a leg covering in place on a horse's leg 50. Again this covering 52 can be a rectangular, flexible and bendable cover having an outer fabric layer 54 made of fire retardant fibers in accordance with the invention. This covering is provided with an attachment arrangement in the form adjustable straps 56, three of which are shown. The straps in use extend parallel to one another. The illustrated attachment devices are in the form of hook and loop straps that cooperate with one another, commonly sold under the trade-mark VELCRO™. If available, the VELCRO™ material should be fire retardant or fire resistant. Otherwise it may be preferable to use metal fasteners such as hooks and buckles that can withstand fire and heat. Again it will be understood that the covering 52 can comprise several layers of materials, the nature of which can depend upon the particular function of the covering. These layers of materials may be stitched together along at least top and bottom edges as indicated at 58 and 60.

FIG. 6 of the drawing illustrates a relatively small wrap or covering 62 shown in a partially rolled up state. This covering 62 can be wrapped around a horse's leg, for example, to provide protection and/or to treat the leg. The outer surface of this wrap is covered with a fabric layer 64 made of fire retardant fibers such as NOMEX™. This small blanket or covering can be held in place on the leg by means of fire resistant ties or straps, each of which extends around the leg and is adjusted to hold the wrap securely but comfortably in place.

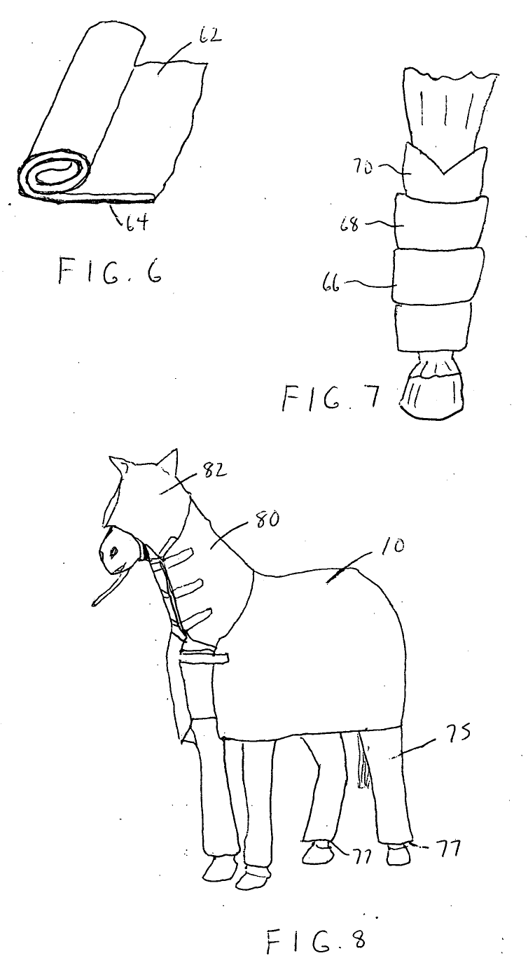

FIG. 7 illustrates another form of leg protector 66, this protector made of a series of pads or cover sections 68 which are connected to each other and each of these sections is able to bend at least to a limited extent relative to the adjacent section. The protector is sized and designed to fit around a section of a horse's leg, for example, the lower, shin section above the hoof. Again, each of the sections 68 is provided with a fabric layer 70 on the outside surface made of fire retardant fibers. There are attachment devices (not shown) for holding this leg protector on the horse's leg in a secure but comfortable manner. A complete description of this leg protector herein is deemed unnecessary since, except for the outer fire retardant layer, this protector is of known construction and these protectors are common in the horse farm industry.

It will be appreciated, that in order to provide maximum fire protection for a horse, two or more of the above described products can be used on one horse with at least one of these products normally being a horse blanket constructed in accordance with the invention. For example, it is highly desirable to protect the four legs of a horse in addition to the horse's body against a fire situation and, for this reason, it may be very desirable to use four fire retardant leg protectors in addition to the described horse blanket.

Shown in FIG. 8 is a horse provided with additional protective coverings over and above a protective horse blanket 10. The additional horse coverings include four leggings 75, one for each of the four legs. Each of these leggings can be constructed in a manner similar to the horse blanket described above, including a fabric layer made of fire retardant fibers, and there is an attachment arrangement (not shown) for securing each legging to the horse. The attachment arrangement can either attach the legging directly to the blanket 10 or it can be in the form of one or more suspenders to wrap around the horse's rump or shoulder/neck. Preferably, each legging 75 covers most of the leg of the horse, although the hoof can be left exposed as shown (as this will help avoid tripping). Preferably each legging 75 can be provided with an elastic bottom at 77 (similar to that provided on sweat pants wore by humans) and the elastic bottom of the legging can come below the coronet band (hairline) of the horse's leg.

An additional protective horse covering shown in FIG. 8 is a separate neck cover 80 which again can be constructed in a manner similar to the blanket 10 with the fabric layer made of fire retardant fibers. In addition, the illustrated horse is fitted with another form of face protector 82 which is cut and shaped to cover at least a major portion of the horse's face and its ears and this face protector extends down to the neck cover 80. The nostrils and mouth of the horse are left uncovered so that the horse is free to breath. If desired, the face protector can extend down so as to also cover the lower jaw of the horse while at the same time providing the necessary ventilation around the nostrils for the horse to breath.

In addition to the coverings already described, another possible covering which can be made in accordance with the invention is a small or partial horse blanket sized and adapted to fit around the belly of the horse and adapted for attachment at the sides to a horse blanket of the invention that extends only over the back and sides of the horse. With this arrangement, the main blanket can be left on the horse when desired to keep the horse warm and comfortable but the bottom blanket section could be left off when there is no danger or fire or when the horse is being attended to. Then, at night, the bottom blanket or cover can be attached to the main blanket to provide increased and improved fire protection.

It will be appreciated that one advantage of a horse blanket or other horse covering having an outer layer of the blanket or covering made of fire retardant material is that it is only necessary to apply and attach the horse blanket or covering once to the horse and it is not necessary to apply first a standard horse blanket with little fire protection capability and then, over this blanket, attach or mount a separate fire retardant sheet or fabric layer.

Various modifications and changes can be made to the described and illustrated horse coverings and horse apparel without departing from the spirit and scope of this invention.

I claim:

1. A horse covering comprising horse apparel including a flexible fabric layer adapted for wear on a body or a body part of a horse, said fabric layer being made of fire retardant fibers, and an attachment arrangement for securing said horse apparel to the body or body part of the horse.

2. A horse covering according to claim 1 wherein said fabric layer is made of NOMEX™and NOMEX III A™.

3. A horse covering according to claim 1 wherein said fabric layer is made of KEVLAR™.

4. A horse covering according to claim 2 wherein said attachment arrangement is made of NOMEX™ or NOMEX III A™.

5. A horse covering according to claim 2 wherein said horse apparel is a face cover capable of providing fire protection to a face and eyes of a horse.

6. A horse covering according to claim 2 wherein said horse apparel is a leg cover adapted to cover at least a portion of a horse's leg and said attachment arrangement includes elongate, flexible connecting members selected from a group comprising straps and ties.

7. A horse covering according to claim 1 wherein said attachment arrangement comprises attachment devices which are resistant to fire and extreme heat.

8. A horse covering according to claim 7 wherein said attachment devices each comprise a fire resistant, elongate, flexible strap and a metal fastener selected from the group comprising a hook and a buckle and wherein each attachment device is attached to the horse apparel.

9. A horse covering according to claim 2 wherein said horse apparel is a leg protectior made of a series of interconnected cover sections, said leg protector being sized and constructed to cover a lower portion of a horse's leg.

10. A horse covering according to claim 1 wherein said horse apparel is a legging adapted to cover most of a horse's leg and to fit loosely on the horse's leg during use thereof.

11. A horse covering comprising a horse blanket for covering at least a substantial portion of a horse's body, said blanket having an outer fabric layer made of fire retardant fibers, and attachment devices for securing said blanket to said horse's body.

12. A horse covering according to claim 11 wherein said horse blanket is sized and fitted to allow the blanket to wrap around a belly of the horse's body in order to cover said belly during use of the covering.

13. A horse covering according to claim 11 wherein said outer fabric layer is made of NOMEX™ or NOMEX III A™.

14. A horse covering according to claim 13 wherein said horse blanket has an inner layer adapted for direct contact with the back and sides of a horse during use of said covering and said inner layer is a light sheet of air pervious material.

15. A horse covering according to claim 13 wherein said horse blanket has an inner layer adapted for direct contact with the back and sides of a horse during use of said covering and said inner layer is an insulated coat layer suitable for use in cold weather in order to help keep the horse warm.

16. A horse covering according to claim 11 wherein said outer fabric layer is made of para-aramid fiber.

17. A horse covering according to claim 13 wherein said attachment devices each include an elongate, flexible connector made of NOMEX™ or NOMEX III A™.

18. A horse covering according to claim 17 wherein said attachment devices also include metal fasteners selected from the group comprising metal hooks and metal buckles.

19. A horse covering comprising a sheet consisting of a single layer of fabric made of fire retardant fibers and sized to cover at least a major portion of a horse's body, and an attachment arrangement for securing the covering either to the body of the horse or an underlying horse blanket worn by the horse during use of the covering.

20. A horse covering according to claim 19 wherein said layer of fabric is made of a fire retardant material selected from the group comprising NOMEX™, NOMEX III A™ and KEVLAR™.
